(19) United States
(12) Patent Application Publication
(10) Pub. No.: US 2026/0024987 A1
(43) Pub. Date: Jan. 22, 2026

(54) SUBSEA POWER SWITCHING UNIT

(71) Applicants: Siemens Energy AS, Oslo (NO); SIEMENS ENERGY, INC., Orlando, FL (US)

(72) Inventor: Björn Rasch, Heimdal (NO)

(73) Assignee: Siemens Energy AS, Oslo (NO)

(21) Appl. No.: 19/099,815

(22) PCT Filed: Aug. 2, 2023
(86) PCT No.: PCT/US2023/029318

§ 371 Date: Jan. 30, 2025

(30) Foreign Application Priority Data
Aug. 10, 2022 (GB) 2211669.3

(51) Int. Cl. H02H 7/22

(52) U.S. Cl. CPC H02H 7/22

(57) ABSTRACT

A power supply system for use in a subsea environment includes an external power source operable to deliver a power input. A main circuit breaker is movable between a closed position and an open position. A subsea power switching unit (SPSU) operates in response to the receipt of the power input to deliver power to a plurality of power outputs, for each power output, the SPSU includes a contactor movable between a closed position and an open position, a sensor operable to generate a measurement indicative of one of a current and a voltage of the power output, and a relay operable to compare the measurement to a first threshold and a second threshold, the relay operable in response to the measurement exceeding the first threshold to move the contactor to the open position, and in response to the measurement exceeding the second threshold to sequentially move the main circuit breaker to the open position, move the contactor to the open position, and move the main circuit breaker back to the closed position.

### BACKGROUND

This invention relates to a subsea power switching unit and method of operation, in particular for use with subsea flowline electric heating systems.

Subsea power distribution typically relies upon a topside power source fed via an umbilical to a subsea distribution network. A particular example of where this is used is in heated subsea flowlines using electrical heat tracing systems, or direct electric heating (DEH) principles. Hydrocarbon flow is a key concern in subsea hydrocarbon production. Pipeline heating systems have been developed in order to avoid the risks and cost associated using chemicals to prevent hydrate formation, which required chemicals to be transported to the wellhead and injected into the process fluid. Furthermore, heating systems and other control systems for offshore production may have to operate over long distances, running through long cables, subsea. Improvements to such systems are desirable.

### SUMMARY

In one aspect, a power supply system for use in a subsea environment includes an external power source operable to deliver a power input. A main circuit breaker is movable between a closed position in which the power output is delivered from the external power source and an open position in which the power output is interrupted and is not delivered from the external power source. A subsea power switching unit (SPSU) operates in response to the receipt of the power input to deliver power to a plurality of power outputs, for each power output of the plurality of power outputs, the SPSU includes a contactor movable between a closed position in which power flows from the power input to the power output and an open position in which power does not flow between the power input and the power output, a sensor operable to generate a measurement indicative of one of a current and a voltage of the power output, and a relay operable to compare the measurement to a first threshold and a second threshold, the relay operable in response to the measurement exceeding the first threshold to move the contactor to the open position, and in response to the measurement exceeding the second threshold to sequentially move the main circuit breaker to the open position, move the contactor to the open position, and move the main circuit breaker to the closed position.

In another aspect, a method of operating a power supply system includes delivering a power input from an external power source to a main circuit breaker, and selectively positioning the main circuit breaker in one of a closed position in which the power output passes through the main circuit breaker from the external power source and an open position in which the power output is interrupted and does not pass through the main circuit breaker. The method also includes directing power from the main circuit breaker to a subsea power switching unit (SPSU), the SPSU operating to deliver power to a plurality of power outputs, for each power output of the plurality of power outputs the SPSU performing the following steps. The SPSU senses a value of one of a current and a voltage for the power output, compares the value to a first threshold and a second threshold, and moves a contactor from a closed position to an open position in response to the value exceeding the first threshold. The SPSU also performs in sequence the following steps in response to the value exceeding the second threshold. The SPSU moves the main circuit breaker to the open position to stop the flow of power from the external power source to the SPSU, moves the contactor to an open position to define a fault contactor, and moves the main circuit breaker to the closed position to deliver power to the SPSU and to each of the plurality of power outputs except the power output connected to the fault contactor.

In accordance with another aspect of the present invention, a subsea power switching unit comprises a subsea power switching unit comprising a pressure resistant housing; a power input from an external power source; a plurality of power outputs to external consumers or loads; a medium voltage contactor for each phase of each power output; and a protection relay for each power output; wherein the power input feeds power to a main busbar coupled to the plurality of contactors, one for each of the power outputs; and wherein the power input and power output connections in the pressure resistant housing comprise subsea wetmatable connectors.

The unit may further comprise a current transformer for each power output feed.

The current transformer monitors the output current and triggers action by the protective relay in the case of a short circuit.

The power switching unit further comprises a voltage transformer coupled between the main busbar and the protective relay.

The voltage transformer monitors the main busbar voltage and triggers action by the protective relay in the case of the voltage exceeding a predetermined threshold. The voltage transformer is also used for power monitoring and to regulate the main busbar voltage by means of topside equipment, such as a topside transformer with on load tap changer.

The medium voltage range may comprise 1.5 kV AC to 15 kV AC at up to 250 A, in particular in the range 3 kV to 6.6 kV.

The power input may comprise one of DC, single phase AC or three phase AC.

The power outputs may comprise one of DC, single phase AC or three phase AC.

The subsea electrical consumers may comprise at least one of subsea flowline heating cables, subsea motors, subsea control systems, or subsea instrumentation.

The unit may further comprise line insulation monitoring.

In accordance with another aspect of the present invention, a subsea load short circuit protection system comprises at least one of a subsea a subsea transformer or a subsea variable speed drive (VSD); and a subsea power switching unit according to any preceding claim.

In certain application, the subsea power switching unit of the present invention may be connected to primary electrical distribution equipment, such as a subsea variable speed drive, or subsea transformer, whereas in other applications, the unit operations without this additional equipment.

In accordance with another aspect of the present invention, a method of operating a subsea load short circuit protection system comprises monitoring a plurality of subsea power feed lines connected to subsea loads by measuring current at a current transformer or voltage at a voltage transformer connected to each individual feed line; comparing the measured current or voltage with a first threshold and a second threshold; if the measured current or voltage exceeds only the first threshold, instructing a contactor in the feed line to open; or, if the measured current or voltage exceeds both the first and the second threshold, instructing a topside circuit breaker to open first.

The method may further comprise detecting that the topside breaker is open and instructing the subsea breaker on the faulty feedline to open.

The method may further comprise detecting that the subsea contactor on the faulty feedline has been opened and sending an instruction from the protection relay to the topside breaker to close the topside breaker again.

The method may further comprise using the power switching unit to remotely switch a subsea VSD to operate in 3 phase motor mode, or alternatively in single phase mode for direct electric heating.

### BRIEF DESCRIPTION OF THE DRAWINGS

To easily identify the discussion of any particular element or act, the most significant digit or digits in a reference number refer to the figure number in which that element is first introduced.

FIG. 1 illustrates an example of a subsea electric heating system in which the power switching unit and method of the present invention may be applied.

FIG. 2 illustrates more detail of the power switching unit according to the invention.

FIG. 3 illustrates further detail of the power switching unit of FIG. 2.

FIG. 4 is a single line diagram of the power switching unit of the present invention.

FIG. 5 is a flow diagram of a method of operation of the subsea power switching unit of the present invention.

### DETAILED DESCRIPTION

The present invention addresses the problems faced in supplying power to consumers of subsea production systems and pipelines, typically medium voltage subsea consumers requiring power at up to 15 kV and at up to 250 A. Conventionally, the power distribution has been done topside with circuit breakers and traditional protection relays which results in complicated and expensive cable arrangements from topside to each of the consumers, separately, subsea. For production pipelines that need heating and boosting because of the distance and flow conditions over which they operate, the supply may need to operate over long distances, for example, 10 or 20 kilometres, or more. Examples of consumers include electric trace heating systems, where cables are wrapped around the inner pipeline in a pipe-in-pipe configuration and provide heat to the pipeline by conduction, or direct electric heating systems where the electricity flows through and heats up the metal pipeline itself, without additional heating wires around the pipeline. Since an electrical flowline heating system is normally represented by several independent heating cables embedded in the flowline construction, a topside distribution requires many parallel subsea cables to feed the heating system. The same applies for other subsea consumers of electrical power, such as direct electric heating, or subsea motors, instrumentation, or control.

A subsea flowline heating power supply system for providing electrical power for heating a subsea pipeline, either along its whole length, or in sections, arranged subsea on the seafloor may be supplied by only one three-phase AC supply, by a single-phase AC supply, or by a DC supply, with the distribution to the individual heating cables being done subsea. Conventionally, the source of that power has been topside, and the supply is made along the multiple cables, whereas the present invention allows the supply to be via an umbilical to a subsea power distribution unit, through which the heating system is supplied with power. From the distribution unit, the output may be three-phase AC, or single-phase AC, if necessary, converted by means of a converter if the input is different to the output, with suitable control to maintain the power factor at or close to one, so that the output power and corresponding heating of the pipeline are maintained to avoid problems with the process fluid flow.

The present invention provides for protection of the loads by the particular arrangement of a subsea variable speed drive (VSD) or a subsea transformer, or both and a subsea power switching unit (SPSU) according to the invention. Medium voltage (MV) switching of loads or motors, using a gas filled cannister with approximately one bar to two bar pressure (100 kPa to 200 kPa, to contain the SPSU, is enabled by the use of the SPSU and so being able to protect the loads. Subsea loads to which the electrical power distribution is directed may include various subsea consumers, such as, subsea flowline heating cables, subsea motors, or other subsea electrical consumers e.g., control systems or instrumentation. Current transformers are provided on all outputs of the SPSU and one or more voltage transformers, for example three, single-phase voltage transformers, for a three-phase input, are provided at the main busbar input to protection relays, which in combination with the protection relays monitor each output current, or the main busbar voltage. Thus, MV supply may be distributed to a plurality of subsea consumers, for example two or more, but more typically four or more consumers. The consumers are individually protected for overload and fault conditions, e.g., short circuit and ground faults by the transformers and relays. The number of consumers may be chosen so that there is redundancy, allowing one of any pair to be disconnected at the switching unit in the event of a fault and the other consumer to continue to operate.

Conventionally, there has been no effective solution available for subsea distribution of medium voltage power for smaller consumers. At the higher currents, there may be limitations due to the connector cables inside the cannister, so the voltage and currents used in operation are chosen accordingly. Instead, the distribution has been controlled topside with circuit breakers and traditional protection relays which results in a complicated and expensive cable arrangement to the subsea consumers. By contrast, the present invention enables standard medium voltage vacuum contactors arranged in a pressure resistant cannister to be used, with subsea wetmatable connectors and integrated individual protection and monitoring functions on each output feeder. Medium voltage operation for such consumers may be in the range 1.5 kV to 15 kV at up to 250 A, more typically in the range of 3 kV to 6.6 kV, 7.2 kV, or up to 12 kV and at up to 250 A. The system is arranged and dimensioned to work without fuses, whilst still being able to cope in the event of a short circuit.

The protection philosophy provides each output feeder with individual protection using a protection relay, such as SIPROTEC™ and optionally includes a line insulation monitoring device (LIM) which continuously monitors resistance to ground for isolated systems. Incorporating protection relays allows for a compact envelope for the SPSU, whilst providing the necessary short circuit protection to allow contactors to be used, rather than separate circuit breakers. The option of adding a line insulation monitoring system in the cannister in combination with the relay, further improves reliability of operation and gives the best protection possible. The novel combination of an MV contactor and protective relays in a one atmosphere canister with wet mate connectors to the consumers ensures that power distribution for relatively low voltage consumers, i.e., below 15 kV can be achieved with less complexity and lower cost than existing systems with higher rated subsea switchgears.

The use of subsea transformers reduces the short circuit power, in the event of a short circuit occurring, so that the contactor can clear fault currents for the individual loads. Normally, contactors cannot clear faults, but the arrangement of the SPSU means that the maximum short circuit current is lower than the switching capability of the contactors because of the impedance in the transformer and the subsea cable reducing the short circuit power. Optionally, a programmed protective relay may be arranged such that if the current is too high for the contactor at any point, the opening of the contactor is delayed, or another breaker elsewhere is instructed to open, which avoids damaging the subsea switching unit, which is difficult and expensive to replace.

For smaller subsea consumers this invention offers a compact and cost-effective solution compared to other subsea switchgear using circuit breakers designed for higher voltages, i.e. well above 15 kV, or compared to topside solutions. The invention also offers local fault sensing and condition monitoring directly at the consumer, as well as better selectivity to isolate faults at the source and ensure safe and local fault clearance and enable continued operation of the remaining, non-faulty, consumers.

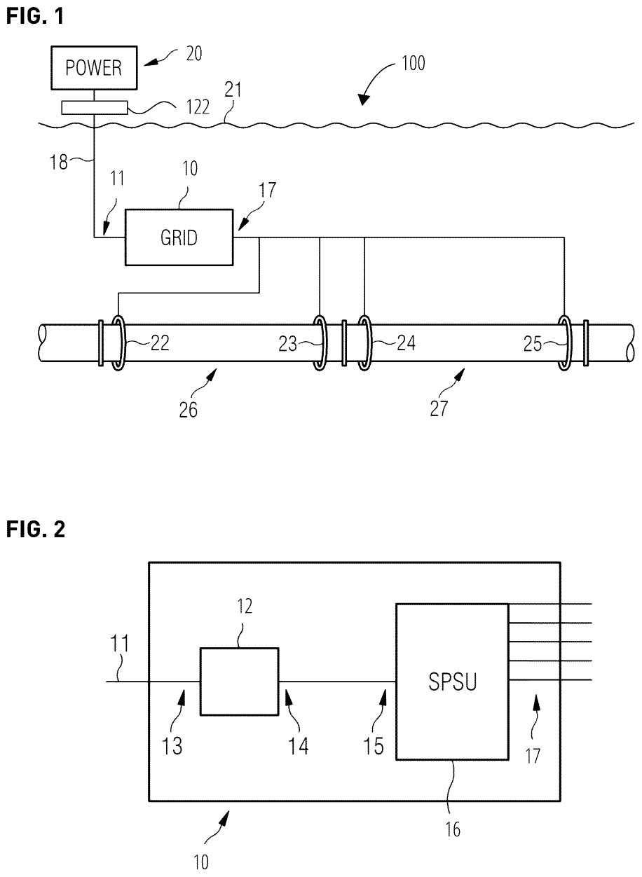

An example of a medium voltage subsea power switching unit is described with reference to an example of a flowline heating system 100 in FIG. 1. FIG. 1 illustrates a general arrangement for a flowline heating system 100, although its application is not limited to subsea flowline heating systems and power supplies to other subsea consumers may be carried out in a similar manner by simply replacing the heating cables with another electrical consumer, such as a subsea motor, at the connections shown in FIG. 1. FIG. 2 shows more detail of the subsea grid 10 of the subsea system.

In the example of FIG. 1, the subsea grid 10 illustrated in more detail in FIG. 2 includes an external subsea transformer 12 that is shown connected to the subsea power switching unit or SPSU 16, although this is an optional feature for heating, provided that there is sufficient input impedance in the cables alone, to provide the necessary protection to allow contactors to be used. The subsea grid 10 is supplied with power from a power source 20 from topside, above the surface of the sea, for example via power cable 11, or an umbilical, into the subsea transformer 12. The power source 20 is sometimes referred to herein as external power, an external power source, non-subsea power, or a non-subsea power source if it is delivered from a non-subsea source such as a ship, the shoreline, or a floating or fixed platform.

The power supply input 13 to the subsea transformer 12 is normally three-phase AC. The input 15 to the SPSU 16 comes directly from an output of the subsea transformer 12. The SPSU 16 is able to receive DC, single-phase AC, or three-phase AC according to what is available. Power at the plurality of power outputs 17 of the SPSU 16 may be converted if the loads need a different form e.g., from DC to AC, from three-phase AC to single-phase AC, or may take the same form as the power input. For the flowline heating system 100 example, topside power source 20 is fed to the cable 11 of the subsea grid 10 and the SPSU 16 outputs supply power (via various power outputs 17) to different sections 26, 27 of a subsea pipeline, where the heating wires are embedded in the construction of the pipeline, typically below a layer of insulation and in contact with the pipeline.

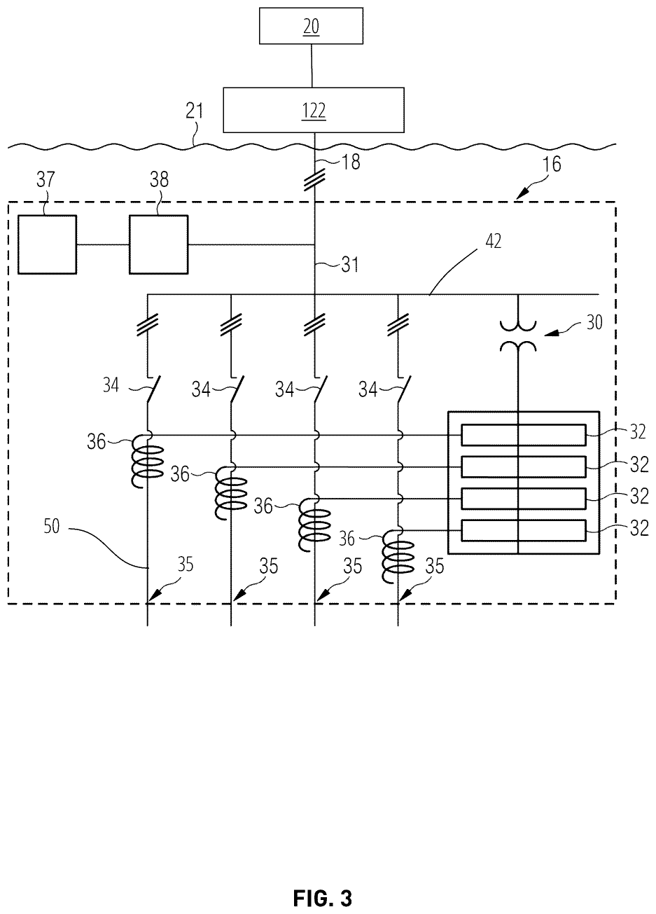

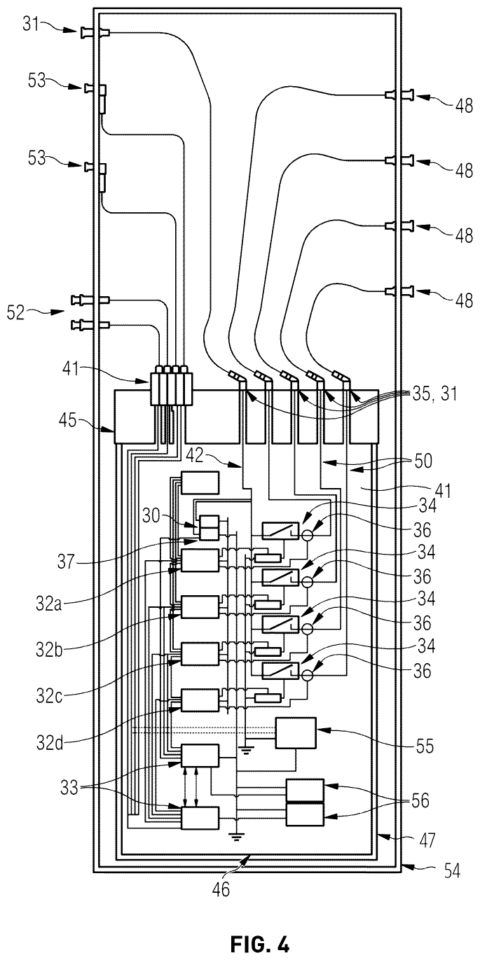

In another example, as described in the later figures, with respect to the present invention, a subsea transformer 30 (shown in FIG. 3) may be incorporated in a canister 47 (shown in FIG. 4) with the SPSU 16, rather than using the external subsea transformer 12. In this example, within the canister 47, the transformer 30 is hard wired to the SPSU 16 and mounted in one common installation structure 41.

In an alternative example, the external subsea transformer 12 may be replaced by a variable speed drive (not shown), for example where a variable frequency input is required, for example for direct electric heating of the pipeline. The variable speed drive may comprise a plurality of series-connected power cells. Each power cell may comprise an inverter and a bypass device (not shown) to selectively bypass the power cell, in the case of a fault. For other examples, not shown, such as subsea motors or other subsea loads, the power outputs 17 from the SPSU 16 would be connected to the appropriate inputs of the motor or other loads, rather than ends of a pipeline.

FIG. 3 illustrates more detail of the main electrical arrangement of the SPSU 16 of the present invention, showing features of the internal arrangement of protective relays, energy storage, contactors and cables. The components shown in FIG. 3 and FIG. 4 are arranged inside the canister 47 (shown in FIG. 4) to create an advantageous arrangement that can meet the mechanical requirements for shock and vibrations as well as temperatures. Within the SPSU 16, a plurality of industry standard medium voltage (MV) contactors 34 are arranged to receive a power input 31 from the power source 20. The MV contactors 34 are arranged in parallel with each serving to connect a main busbar 42 to individual cables 50 that in turn connect to individual output feeders 35.

The power input 31 also feeds into protection relays 32 via a voltage transformer 30. The voltage transformer 30 measures the voltage on the main busbar 42. The voltage transformer 30 is coupled between the main busbar 42 and the protective relays 32a, 32b, 32c, 32d. The voltage transformer 30 monitors the voltage of the main busbar 42 and triggers action by the protective relays 32 in the case of the voltage exceeding a predetermined threshold. The voltage transformer 30 may also be used for power monitoring and to regulate the voltage of the main busbar 42 by means of topside equipment, such as a topside transformer with a load tap changer.

Current transformers 36 on each cable 50 to each output feeder 35 measure the current in each phase of each output feeder 35, so that the current of each connected load may be monitored individually. The protection relays 32 issue trip commands to the contactors 34 in the event of a fault being detected. Communication with topside or other subsea router modules (not shown) may be provided by an ethernet connection to a built-in ethernet switch 33 (shown in FIG. 4), or via a standardized subsea interface, such as a subsea instrumentation interface standard (SIIS) level 2, or level 3, interface. The SPSU 16 may be provided with an auxiliary power supply, such as a 230V AC to 400 V AC supply, or a 400V DC power supply which is fed into the unit through an auxiliary power input 53.

The SPSU is designed to operate without the use of fuses. This fuseless design means that each feeder 35 or power output 17 is set up using a protection philosophy that where a fault current occurs, it can be cleared safely by the contactors 34 in the SPSU 16, rather than relying on a fuse to break the contact if the current exceeds a value that the contactor can safely handle. In addition to the basic contactors 34 and protection relays 32 of the SPSU 16, additional system components add to the protective effect and prevent the current at the contactors exceeding a value that can be effectively handled without damage to the switching unit. These system components include the subsea input voltage transformer 30, a topside transformer (not shown), and a long subsea input cable 18.

The input impedance of the SPSU 16 is chosen such that the maximum subsea short circuit current is below the maximum breaking capacity of the subsea medium voltage contactors 34. The input impedance may be distributed in several components of the system, for example, in the topside transformer and the subsea voltage transformer 30, if used, or in the subsea cable. Typically, the tested breaking capability of the vacuum contactors used is more than half as much again as the typical maximum short circuit current expected in the case of a fault subsea. For example, testing is at 3.6 kA for a typical maximum short circuit current of around 2 kA. This difference in maximum breaking capability and expected maximum short circuit current means that a trip command from the protective relay 32 can safely clear an individual fault locally subsea. Suitable programming of the relays 32 may be used to ensure immediate and fast tripping of the contactors 34 locally if the detected fault current is below 3.6 kA. If higher currents than the rated value, in this example, higher than 3.6 kA, are detected, then tripping of the contactors 34 is delayed and instead a fast and immediate trip command is sent to a primary breaker 122 (sometimes referred to as a main circuit breaker, main breaker, topside breaker, or the like) located topside to clear the fault. In either case, the equipment is protected from further damage by choosing the most suitable trip command to clear the fault, with known and dimensioned faults within the maximum limit being cleared locally with the required selectivity, whilst unintentional faults are cleared at the primary breaker 122 located topside. Due to the high short circuit withstand capacity of the selected contactors 34, a small fault clearing delay does not cause any damage to the equipment.

With reference to FIG. 3, a further feature that may be provided is ground fault detection, using the line insulation monitoring components 37, 38. Normally the subsea system is operated isolated to ground. An example of a typical subsea consumer is electrical heat tracing cables 22 to 25 for flowline heating, operated in a three-phase isolated system. A single-phase ground fault can be detected by providing a built-in line insulation monitoring (LIM) system 37 coupled to the power supply by a relatively high voltage coupling device 38 (i.e., above the low voltage upper threshold of 1.5 kV, which for control systems is deemed to be high voltage, but still within the range that for power would fall within medium voltage) that continuously monitors resistance to ground. A three-phase ground fault may be detected by over-current protection which is programmed into the protective relay 32. Such functions typically follow American National Standards Institute (ANSI) standards, where specific ANSI functions have a particular effect. However, detection of ground faults is still challenging since the fault is normally a high impedance fault and very limited over-current can be detected. One ANSI function, 59N, detects insulation faults by measuring residual voltage in isolated neutral systems, detecting lack of symmetry and imbalance. Combining settings in the protective relay 32 of ANSI 50/51, 59N with line insulation monitoring 37 improves the chances of getting good detection of ground faults over the complete length of the flowline 22 to 25. For overcurrent protection, the use of ANSI 50/51 detects an overload, but not high impedance faults, whereas ANSI 59N increases the reach of detection, so resulting in a more effective fault detection system.

FIG. 4 is a single line diagram of a possible implementation of the SPSU 16, showing the internal arrangement of the protection relays 32 and contactors 34. A canister 47, having a housing, typically designed for water pressure down to 3000 m water depth is filled with a suitable gas, such as industrial dry air at approximately 1.5 bar pressure. Within the canister 47 the various components may be installed on a rack 41 which is supported mechanically by a lid 45 and by a base 46 of the canister 47 or housing. The medium voltage power input 31 from the main power source 20 and the plurality of medium voltage power feeders 35 to the loads penetrate the lid through watertight seals. Typically, the power connections in and out of the SPSU 16, and specifically a SPSU container 54 are by means of suitable wet mate connectors 48, such as SpecTRON™ connectors. On the inside of the lid 45, the power input cable 42 feeds into the first of the contactors 34 of the variable speed drive and the power output cables 50 for each output 35 return to the lid and connectors 48. The auxiliary power input 53 to power the internal power supply 55 and electronics boards 56 and optional optical fibre inputs 52 have a separate connection system 49 through the lid. Having installed the components on the rack 41, the system may be tested in air according to typical IEC/IEEE standards for switchgear, before closing the cannister.

The gas filled canister 47 contains a series of protective relays 32a, 32b, 32c, 32d on the mounting rack 41, each protective relay 32 being associated with a set of contactors 34, one for each power supply phase output. For a three-phase system, the contactor 34 associated with one relay 32a, is connected in parallel with the contactor 34 associated with the next relay 32b. Similarly, the contactor 34 associated with relay 32b is connected in parallel from the main bus cable 42 with the contactor associated with the next relay 32c and so on. FIG. 4 illustrates an example for three-phase AC, whereas, for single-phase AC, only a single contactor plate would be required for each output 35, in each case, one contactor for each protective relay.

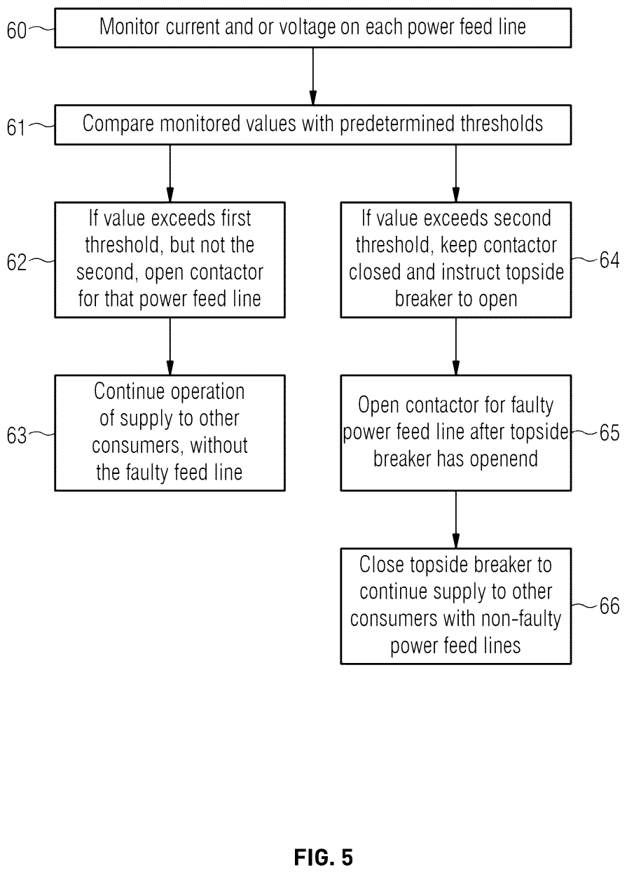

FIG. 5 is a flow diagram illustrating the steps for operating an SPSU 16 of the present invention. During normal operation, outputs from the current transformers 36, or voltage transformers, or both, are monitored (step 60) by the protection relay 32. The monitored values are compared (step 61) at intervals, or continuously, with predetermined thresholds that have been set for the specific application and stored. A first threshold is one which does not exceed the maximum rating for the contactor 34, so the contactor 34 can safely be opened, even if a short circuit has occurred, indicating a fault related to a particular output power line, consumer, or load. A second threshold is one which does exceed the maximum rating for the contactor 34, which would prevent the contactors 34 from being opened safely.

If the first threshold is exceeded, but not the second (step 62), the contactor 34 for that feed line is opened and supply to the load fed by that line is suspended. Operation of the remaining feedlines continues as indicated by step 63. If the second threshold is also exceeded, then the protection relay 32 sends an instruction to the topside primary breaker 122 to open (step 64). After the topside primary breaker 122 has been opened, cutting off topside power to all consumers or loads subsea that are fed from that topside source, the protective relay 32 uses power from an auxiliary power input or energy storage device locally, or auxiliary power not fed from the topside supply, to operate. The protective relay 32 then instructs the local contactor 34 to open on the faulty feed line (step 65). Thereafter, an instruction is sent by the protection relay 32 to the topside primary breaker 122 to close the topside primary breaker 122 again (Step 66), thereby restoring power to all except the faulty subsea feed line and load.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, act, or function is an essential element, which must be included in the claim scope: the scope of patented subject matter is defined only by the allowed claims. Moreover, none of these claims are intended to invoke a means plus function claim construction unless the exact words “means for” are followed by a participle.

What is claimed is:

1. A power supply system for use in a subsea environment, the power supply system comprising:
an external power source operable to deliver a power input;
a main circuit breaker movable between a closed position in which the power output is delivered from the external power source and an open position in which the power output is interrupted and is not delivered from the external power source; and
a subsea power switching unit (SPSU) operable in response to the receipt of the power input to deliver power to a plurality of power outputs, for each power output of the plurality of power outputs, the SPSU including:
a contactor movable between a closed position in which power flows from the power input to the power output and an open position in which power does not flow between the power input and the power output;
a sensor operable to generate a measurement indicative of one of a current and a voltage of the power output; and
a relay operable to compare the measurement to a first threshold and a second threshold, the relay operable in response to the measurement exceeding the first threshold to move the contactor to the open position, and in response to the measurement exceeding the second threshold to sequentially move the main circuit breaker to the open position, move the contactor to the open position, and move the main circuit breaker to the closed position.

2. The power supply system of claim 1, further comprising an auxiliary power source operable to deliver an auxiliary power input to the SPSU, wherein in response to the measurement exceeding the second threshold the relay uses the auxiliary power to move the contactor to the open position.

3. The power supply system of claim 2, wherein the auxiliary power source is separate from the external power source and is located subsea.

4. The power switching unit of claim 1, wherein the sensor includes a current transformer.

5. The power switching unit of claim 1, wherein the SPSU further comprises a busbar arranged to receive the power input, and wherein a voltage transformer is coupled between the main busbar and the relay.

6. The power switching unit of claim 1, wherein the power input has a voltage that falls within a medium voltage range between 1.5 kV AC and 15 kV AC at up to 250 A.

7. The power switching unit of claim 6, wherein the voltage of the power input is between 3 kV and 6.6 kV.

8. The power switching unit of claim 1, wherein the subsea electrical consumers comprise at least one of subsea flowline heating cables, subsea motors, subsea control systems, or subsea instrumentation

9. The power supply system of claim 1, wherein the contactor is a vacuum contactor.

10. The power supply system of claim 1, wherein the first threshold and the second threshold are each a current and wherein the second threshold is greater than the first threshold.

11. The power supply system of claim 1, wherein the external power source and the main circuit breaker are provided from a non-subsea source and the SPSU is located subsea.

12. A method of operating a power supply system, the method comprising:
delivering a power input from an external power source to a main circuit breaker;
selectively positioning the main circuit breaker in one of a closed position in which the power output passes through the main circuit breaker from the external power source and an open position in which the power output is interrupted and does not pass through the main circuit breaker;
directing power from the main circuit breaker to a subsea power switching unit (SPSU), the SPSU operating to deliver power to a plurality of power outputs, for each power output of the plurality of power outputs the SPSU performing the following steps:
sensing a value of one of a current and a voltage for the power output;
comparing the value to a first threshold and a second threshold;
moving a contactor from a closed position to an open position in response to the value exceeding the first threshold; and
performing in sequence the following steps in response to the value exceeding the second threshold:
moving the main circuit breaker to the open position to stop the flow of power from the external power source to the SPSU;
moving the contactor to an open position to define a fault contactor; and
moving the main circuit breaker to the closed position to deliver power to the SPSU and to each of the plurality of power outputs except the power output connected to the fault contactor.

13. The method of operating the power supply system of claim 12, further comprising, in response to the value exceeding the second threshold delivering power to the contactor and the SPSU from an auxiliary power source to move the contactor to the open position.

14. The method of operating the power supply system of claim 13, wherein the auxiliary power source is separate from the external power source and is located subsea.

15. The method of operating the power supply system of claim 12, further comprising delivering the power input at a voltage that falls within a medium voltage range between 1.5 kV AC and 15 kV AC at up to 250 A.

16. The method of operating the power supply system of claim 15, wherein the voltage of the power input is between 3 kV and 6.6 kV.

17. The power supply system of claim 12, wherein the first threshold and the second threshold are each a current and wherein the second threshold is greater than the first threshold.

18. The power supply system of claim 12, further comprising positioning the external power source and the main circuit breaker in a non-subsea position and positioning the SPSU subsea.

19. A subsea power switching unit comprising:
a pressure resistant housing;
a power input from an external power source;
a plurality of power outputs to external consumers or loads;
a medium voltage contactor for each phase of each power output; and
a protection relay for each power output; wherein the power input feeds power to a main busbar coupled to a plurality of contactors, one for each of the power outputs; and wherein the power input and power output connections in the pressure resistant housing comprise subsea wetmatable connectors.

20. The power switching unit of claim 19, wherein the unit further comprises a current transformer for each power output.

21. The power switching unit of claim 19, wherein the power switching unit further comprises a voltage transformer coupled between the main busbar and the protection relay.

22. The power switching unit of claim 19, wherein the medium voltage range comprises 1.5 kV AC to 15 kV AC at up to 250 A, in particular in the range 3 kV-6.6 kV.

23. The power switching unit of claim 19, wherein the power input comprises one of DC, single phase AC or three phase AC.

24. The power switching unit of claim 19, wherein each of the power outputs of the plurality of power outputs comprise one of DC, single phase AC or three phase AC.

25. The power switching unit of claim 19, wherein the external consumers or loads comprise at least one of subsea flowline heating cables, subsea motors, subsea control systems, or subsea instrumentation.

26. The power switching unit of claim 19, wherein the subsea power switching unit further comprises line insulation monitoring.

27. A subsea load short circuit protection system comprising at least one of a subsea transformer or alternatively a subsea variable speed drive (VSD); and a subsea power switching unit according to claim 19.

28. A method of operating a subsea load short circuit protection system, the method comprising:
monitoring a plurality of subsea power feed lines connected to subsea loads by measuring current at a current transformer or voltage at a voltage transformer connected to each individual subsea power feed line;
comparing a measured current or a measured voltage with a first threshold and a second threshold;
if the measured current or measured voltage exceeds only the first threshold, instructing a contactor in the subsea power feed line to open; or, if the measured current or measured voltage exceeds both the first threshold and the second threshold, instructing a topside circuit breaker to open.

29. The method of claim 28, wherein the method further comprises detecting that the topside circuit breaker is open and instructing the subsea breaker on the feedline for which the measured current or measured voltage exceeds the first threshold to open.

30. The method of claim 28, wherein the method further comprises detecting that the subsea contactor on the feedline for which the measured current or measured voltage exceeds the first threshold has been opened and then sending an instruction to the topside circuit breaker to close.

31. The method of any of claim 28, wherein the method further comprises using the power switching unit to remotely switch a subsea VSD to operate in 3 phase motor mode, or alternatively to operate in single phase mode for direct electric heating.
